(19) United States
(12) Patent Application Publication
(10) Pub. No.: US 2018/0182561 A1
(43) Pub. Date: Jun. 28, 2018

(54) PHOTOELECTRIC CONVERSION ELEMENT AND ELECTRONIC COMPONENT HAVING THE SAME

(71) Applicant: TAIYO YUDEN CO., LTD., Tokyo (JP)

(72) Inventors: Hidenori SOMEI, Takasaki-shi (JP); Takeyuki FUKUSHIMA, Takasaki-shi (JP)

(21) Appl. No.: 15/840,735

(22) Filed: Dec. 13, 2017

(30) Foreign Application Priority Data
Dec. 22, 2016 (JP) 2016-249194

(51) Int. Cl. H01G 9/20

(52) U.S. Cl. CPC H01G 9/2013; H01G 9/2031; H01G 9/2059; H01G 9/2027

(57) ABSTRACT

In an embodiment, a photoelectric conversion element includes an electrode 1, a counter-electrode 2, and an electrolyte layer 3 interposed between the electrode 1 and the counter electrode 2, wherein: a semiconductor oxide layer 10, as well as semiconductor oxide grains 21 and sensitizing dye 22 fixed via the semiconductor oxide layer 10, are provided on at least a part of a face of the electrode 1 facing the counter-electrode 2; the semiconductor oxide layer 10 has a film structure constituted by grains which are more densely packed than are the fixed semiconductor oxide grains 21; the electrolyte layer 3 contains I₃⁻ and I⁻; and the concentration of I⁻ in the electrolyte layer 3 is 1 to 10 mol/L and is 2 million to 200 million times that of I₃⁻. The photoelectric conversion element is capable of generating a large amount of electricity and high electrical current.

### BACKGROUND

### Field of the Invention

The present invention relates to a photoelectric conversion element and an electronic component having such photoelectric conversion element.

### Description of the Related Art

Currently, crystalline silicon photovoltaic cells are the most popular type of photovoltaic cell modules used in a wide range of applications including residential rooftop modules for selling electricity and large-scale generation modules such as Mega Solar products. Crystalline silicon photovoltaic cells offer high photoelectric conversion efficiency when irradiated with sunlight, and products with a photoelectric conversion efficiency in a range of 20% to 30% are also available of late. However, the lower the illumination intensity of the light irradiated on a crystalline silicon photovoltaic cell, the smaller the amount of electricity generated by the cell becomes, meaning that, if light from a fluorescent lamp (equivalent to 200 lux) is irradiated, for example, the cell generates virtually zero electricity.

Development of photoelectric conversion elements that use indoor light as a light source is underway in recent years, and the latest amorphous silicon photovoltaic cells generate far more electricity per unit area compared to conventional ones. In particular, dye-sensitized photovoltaic cells are performing markedly better at low-illumination intensities, and regeneration of energy from indoor light is becoming a real possibility. According to Patent Literature 1, low-illumination receiving light of low-illumination intensity efficiently is important for a dye-sensitized photovoltaic cell module designed for low-illumination intensity applications.

Also, Patent Literature 1 describes electrolyte compositions for low-illumination intensity applications; specifically, it states that the concentration of triiodide ions (I₃⁻) that act as an electron carrier should be in a range of 0 to 6×10⁻⁸ mol/L. This concentration is approx. one-millionth the concentration of such ions in electrolyte used for dye-sensitized photovoltaic cells that work under sunlight irradiation (1×10⁻² to 8×10⁻² mol/L), and it is stated that, as fewer electrons generate under irradiation at low-illumination intensity, the carrier concentration becomes lower and therefore leak current can be reduced.

### BACKGROUND ART LITERATURES

[Patent Literature 1] Japanese Patent Laid-open No. 2016-167604

### SUMMARY

However, the inventors of the present invention found, after studying in earnest, that controlling the concentration of I₃⁻ alone is not enough to reduce leak current. In light of this circumstance, an object of the present invention is to provide a photoelectric conversion element capable of generating a large amount of electricity and high electrical current in an environment of low-illumination intensity.

Any discussion of problems and solutions involved in the related art has been included in this disclosure solely for the purposes of providing a context for the present invention, and should not be taken as an admission that any or all of the discussion were known at the time the invention was made.

After studying in earnest, the inventors of the present invention completed the invention described below.

According to the present invention, the photoelectric conversion element has an electrode, a counter-electrode, and an electrolyte layer sandwiched between the electrode and the counter-electrode. The electrode has, at least partially on the side facing the counter-electrode, a semiconductor oxide layer as well as semiconductor oxide grains and sensitizing dye. The semiconductor oxide grains and sensitizing dye are fixed via the semiconductor oxide layer. The semiconductor oxide layer has a film structure which is denser than the fixed semiconductor oxide grains. The electrolyte layer contains I₃⁻ and iodide ions (I⁻). The concentration of I⁻ in the electrolyte layer is in a range of 1 to 10 mol/L. The concentration of I⁻ in the electrolyte layer is 2 million to 200 million times that of I₃⁻.

Under the present invention, the presence of the semiconductor oxide layer having a dense film structure prevents so-called “reverse electron migration,” and thereby allows more I⁻ to be contained in the electrolyte layer. By increasing the concentration of I⁻ in the electrolyte layer this way, the amount of electricity generated, and the electrical current that can be taken out, can be increased in an environment of low-illumination intensity, in particular.

For purposes of summarizing aspects of the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description which follows.

### BRIEF DESCRIPTION OF THE DRAWINGS

These and other features of this invention will now be described with reference to the drawings of preferred embodiments which are intended to illustrate and not to limit the invention. The drawings are greatly simplified for illustrative purposes and are not necessarily to scale.

FIG. 1 is a schematic partial cross-sectional view of an example of a photoelectric conversion element according to the present invention.

### DESCRIPTION OF THE SYMBOLS

1: Electrode 2: Counter-electrode 3: Electrolyte layer 10: Semiconductor oxide layer 21: Semiconductor oxide grain 22: Sensitizing dye

### DETAILED DESCRIPTION OF EMBODIMENTS

The present invention is described in detail by referring to the drawing as deemed appropriate. It should be noted, however, that the present invention is not limited to the illustrated embodiment and that, because characteristic parts of the present invention may be emphasized in the drawing, the scale of each part of the drawing is not necessarily accurate.

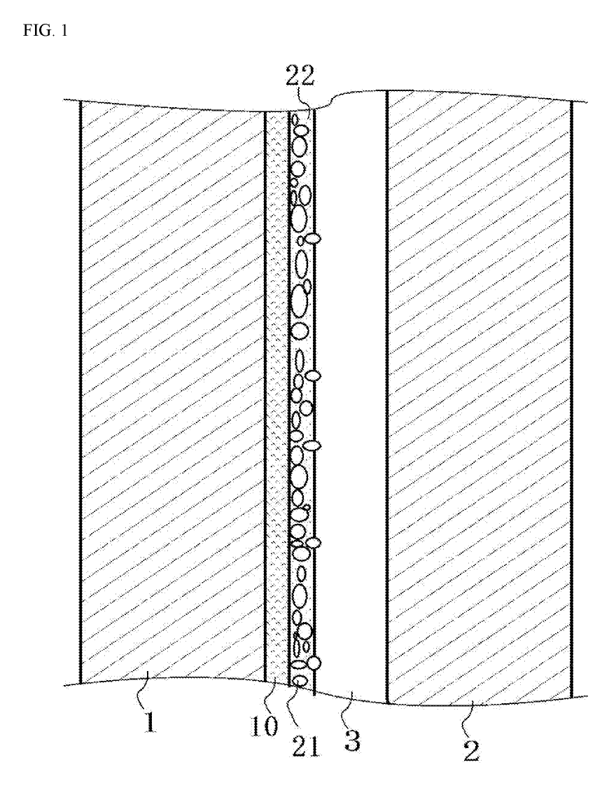

FIG. 1 is a schematic partial cross-sectional view of an example of a photoelectric conversion element according to the present invention. The photoelectric conversion element has a pair of electrodes 1, 2 and an electrolyte layer 3 sandwiched between them. One of the pair of electrodes is referred to as “electrode 1” and the other, “counter-electrode 2,” below.

The electrode 1 functions as a negative electrode of the photoelectric conversion element. For the electrode material, any prior art relating to negative electrode material for photoelectric conversion elements may be referenced as deemed appropriate. In view of the importance of high conductivity and translucency, for example, the electrode may be formed on the surface of a glass substrate or other translucent substrate using zinc oxide, indium-tin complex oxide, laminate consisting of indium-tin complex oxide layers and silver layers, antimony-doped tin oxide, fluorine-doped tin oxide (FTO), or the like. Among these, FTO is preferred as it offers particularly high conductivity and translucency. The thickness of the electrode 1 may be set to any value, but one in a range of 0.1 μm to 10 μm is preferred, for example. Preferably the surface resistance of the electrode 1 is low, such as 200Ω/□ or less, for example. It should be noted that, with many photoelectric conversion elements used under sunlight, sheet resistance of the electrode 1 is approx. 10Ω/□. However, it is different with photoelectric conversion elements for indoor use, which are assumed to be used under a fluorescent lamp, etc., having lower illumination intensity than sunlight, because they generate fewer photoelectrons (less photoelectric current) and are therefore less vulnerable to the negative effect of the resistance component in the electrode 1, which means that the sheet resistance of the electrode 1 need not be extremely low, and may be in a range of 20Ω/□ to 200Ω/□, for example.

A semiconductor oxide layer 10, semiconductor oxide grains 21, and sensitizing dye 22, are provided at least partially on one side of the electrode 1. It is important that semiconductor oxides are used in two different forms, or specifically in the semiconductor oxide layer 10 form and in the semiconductor oxide grain 21 form. The semiconductor oxide grains 21 are fixed on the surface of the electrode 1 via the semiconductor oxide layer 10. The semiconductor oxide layer 10 constitutes a denser film structure than the aggregate of semiconductor oxide grains 21.

Presence of the semiconductor oxide grains 21, and that of the semiconductor oxide layer 10 having a denser film structure, can be confirmed by electron microscope observation of a cross-sectional structure, accompanied by chemical composition analysis. Specifically, as the surface of the electrode 1 is approached from a point away from the surface of the electrode 1, the semiconductor oxide grains 21 of relatively large grain sizes are observed where they are gathered together with partial gaps in between, and as the surface of the electrode 1 is approached further, a film structure where the semiconductor oxide grains of relatively small grain sizes are closely packed is observed, and consequently this film structure can be identified as the semiconductor oxide layer 10.

Preferably the sizes of individual semiconductor oxides constituting the semiconductor oxide layer 10 are roughly 0.1 to 5 nm. On the other hand, preferably the sizes of individual semiconductor oxide grains 21 are roughly 5 nm to 1 μm. The thickness of the semiconductor oxide layer 10 may be set to any value as deemed appropriate, but preferably one in a range of 0.1 to 10 nm.

The material of the semiconductor oxide layer 10 may be the same as or different from the material of the semiconductor oxide grain 21, where any one type of material may be selected from oxides of metals such as Cd, Zn, In, Pb, Mo, W, Sb, Bi, Cu, Hg, Ti, Ag, Mn, Fe, V, Sn, Zr, Sr, Ga, Si, Cr, and Nb, perovskite oxides such as SrTiO₃ and CaTiO₃, and the like, or any two or more types of materials may be selected therefrom as a compound. In some embodiments, any one or more of the above materials can be explicitly excluded from the usable materials. Among these, TiO₂ is preferred as it is chemically stable and offers excellent photoelectric conversion characteristics.

Methods for manufacturing the semiconductor oxide layer 10 having a dense film structure include, for example, the sol-gel method using an alkoxide that contains a metal to constitute the target oxide. On the other hand, the aggregate of semiconductor oxide grains 21 which is constituted relatively coarsely may be manufactured using, for example, a method whereby a paste containing semiconductor oxide grains is applied and then dried. The manufacturing methods are not limited to the foregoing, and any prior art relating to film formation method involving fine grains may be referenced as deemed appropriate.

The semiconductor oxide layer 10, and the semiconductor oxide grains 21, presumably have different operations.

The semiconductor oxide layer 10 operates as a so-called “reverse electron migration prevention layer,” or specifically it has the role of preventing I₃⁻ from contacting the electrode 1. On the other hand, the semiconductor oxide grains 21 have the role of passing electrons from the dye which is supported on the grain surface and in which light has been absorbed, to the electrode 1, via the semiconductor oxide layer 10, and the semiconductor oxide grains 21 also operate to retain the electrolyte in the pores present near them.

A sensitizing dye 22 is further provided at least partially on one side of the electrode 1. The sensitizing dye 22 is also provided via the semiconductor oxide layer 10. This means that the sensitizing dye 22, and the aforementioned semiconductor oxide grains 21, may be present as an indistinct mixture.

For the material of the sensitizing dye 22, any of various types of dyes such as metal complex dyes and organic dyes may be used. The metal complex dyes include, for example, ruthenium-cis-diaqua-bipyridyl complex, ruthenium-tris complex, ruthenium-bis complex, osmium-tris complex, osmium-bis complex, and other transition metal complexes, as well as zinc-tetra (4-carboxy phenyl) porphyrin, iron-hexacyanide complex, phthalocyanine, and the like. The organic dyes include 9-phenyl xanthene dyes, coumarin dyes, acridine dyes, triphenyl methane dyes, tetraphenyl methane dyes, quinone dyes, azo dyes, indigo dyes, cyanine dyes, merocyanine dyes, xanthene dyes, carbazole compound dyes, and the like.

How the sensitizing dye 22 is added is not limited in any way, and examples include a method to apply a solution containing a sensitizing dye on the semiconductor oxide layer 10, and, in contrast, a method to soak in the aforementioned solution the electrode 5 on which the semiconductor oxide layer 10 has been formed. For the aforementioned solution, water, alcohol, acetonitrile, toluene, dimethyl formamide, etc., may be used, for example.

The counter-electrode 2 operates as a positive electrode of the photoelectric conversion element. The material of the counter-electrode 2 is not limited in any way, and any prior art relating to photoelectric conversion elements may be referenced as deemed appropriate. For example, the same material used for the electrode 1 may be used, or a material having catalytic action providing electrons to a reductant may be contained. Examples of such material having the catalytic action include: metals such as platinum, gold, silver, copper, aluminum, rhodium, indium, etc.; graphite; platinum-supporting carbon; metal oxides such as indium-tin composite oxide, antimony-doped tin oxide, fluorine-doped tin oxide, etc.; and organic semiconductors such as poly(3,4-ethylene dioxythiophene) (PEDOT) and polythiophene. Among these, platinum, graphite, etc., are preferred in particular.

An electrolyte layer 3 is provided between the electrode 1 and the counter-electrode 2. The electrolyte layer 3 may be one constituted by liquid or gel. For the method to manufacture the electrolyte layer 3, any known prior art may be referenced as deemed appropriate. The electrolyte layer 3 may be prepared by dissolving an iodine compound and iodine (I₂) in a solvent, etc., for example. Preferably the iodine compound is: tetrapropyl ammonium iodide or other tetraalkyl ammonium iodide; methyl tripropyl ammonium iodide, diethyl dibutyl ammonium iodide, or other asymmetrical alkyl ammonium iodide; pyridinium iodide or other quaternary ammonium salt iodide compound, and the like. In a solvent, etc., these compounds are ionized and generate ammonium ions containing an alkyl group. When the electrolyte layer 3 contains ammonium ions containing an alkyl group, relatively high voltage can be achieved even at low-illumination intensity.

Furthermore, preferably at least one of the elements constituting the aforementioned alkyl group has been substituted by nitrogen, oxygen, halogen, etc. Additionally, when the ammonium ions contain multiple alkyl groups, preferably at least one of the multiple alkyl groups has been substituted by an aralkyl group, alkenyl group, or alkynyl group. The iodine compound generated from the ionization of these ammonium ions is present, as ions, in the solvent, etc., as described below.

The iodine compound may be 1,2-dimethyl-3-propyl-imidazolium iodide, 1,3-dimethyl-imidazolium iodide, pyridinium iodide, other quaternary ammonium salt iodide compound, and the like.

Here, the concentrations of I⁻ and I₃⁻ contained in the electrolyte layer 3 provide one characteristic of the present invention. The concentration of I⁻ contained in the electrolyte layer 3 is in a range of 1 to 10 mol/L. This concentration is far higher than the concentration of I⁻ in the electrolyte layer of a conventional photoelectric conversion element. The prior art presented a problem in that, when the concentration of I⁻ is high, the viscosity of the electrolyte layer becomes high and the film thickness of the generation layer increases, and consequently the electrolyte does not permeate through the generation layer easily and conductivity drops; under the present invention, however, the concentration of I⁻ can be set high, as mentioned above, partly because the permeability of the electrolyte is enhanced by decreasing the thickness of the two forms of semiconductor oxides, or specifically the semiconductor oxide layer 10 and semiconductor oxide grains 21, but particularly the semiconductor oxide layer 10, and partly because 1,3-dimethyl-imidazolium iodide or other iodine compound that can prevent the viscosity from increasing is used, as described above.

Furthermore, another characteristic of the present invention relates to the concentration ratio of I⁻ and I₃⁻ in the electrolyte layer 3. The concentration of I⁻ in the electrolyte layer 3 is 100 million to 1 billion times that of I₃⁻. This concentration ratio is far higher than the concentration ratio in any known conventional photoelectric conversion element. The concentrations of I⁻ and I₃⁻ are determined by the abundance ratio of iodine I₂ and the aforementioned iodine compound that generates iodine ions I⁻. In a solution, I⁻ and I₂ react with each other to generate I₃⁻ ions according to the formula I⁻+I₂→I₃⁻. This means that, to adjust the concentration ratio of I⁻ and I₃⁻, a very small amount of I₂ can be added to the iodine compound so that the aforementioned chemical reaction progresses and a very small amount of I₃⁻ will be generated. The concentrations of I₃⁻ and I⁻ in the electrolyte layer 3 can be measured using the nuclear magnetic resonance spectrum measurement method, etc.

As the concentration of I⁻ in the electrolyte layer 3 is adjusted to a range of 1 to 10 mol/L, an operation of promoting the electron migration from I⁻ to the sensitizing dye 22 can be expected. As the concentration of I⁻ in the electrolyte layer 3 is adjusted to a range of 100 million to 1 billion times that of I₃⁻, an operation of preventing the electron migration from the electrode 1, semiconductor oxide grains 21, and sensitizing dye 22, to I₃⁻, can be expected. As these operations are combined together, an increase in generation amount, as well as an increase in generation current, can be expected especially in an environment of low-illumination intensity.

In addition, a higher concentration of I⁻ in the electrolyte layer 3 means a lower probability of contact of I₃⁻ with the electrode 1, semiconductor oxide grains 21, and sensitizing dye 22, and consequently a further increase in generation amount can also be expected. The viscosity of the electrolyte layer 3 at 25° C. is preferably 0.1 mPa·s or higher but no higher than 10 mPa·s, or more preferably 0.1 mPa·s or higher but no higher than 2 mPa·s. The viscosity is measured with a rheometer (AR2000 manufactured by TA Instruments) using an aluminum flat plate of 60 mm in diameter, under the conditions of 30 um of gap, 25° C. of temperature, and 4, 40 and 400 s⁻¹ of shear rates.

The solvent in the electrolyte layer 3 is not limited in any way and any solvent, either water-based solvent or organic solvent, may be used so long as it offers excellent ion conductivity. In particular, an organic solvent where the oxidant I₃⁻ and reductant I⁻ can exist in stable state is preferred. Examples of the organic solvent include: dimethyl carbonate, diethyl carbonate, methyl ethyl carbonate, ethylene carbonate, propylene carbonate, and other carbonate compounds; methyl acetate, methyl propionate, γ-butyrolactone, and other ester compounds; diethyl ether, 1,2-dimethoxy ethane, 1,3-dioxisosilane, tetrahydrofuran, 2-methyl-tetrahydrofuran, and other ether compounds; 3-methyl-2-oxazolidinone, 2-methyl pyrolidone, and other heterocyclic compounds; acetonitrile, methoxy acetonitrile, propionitrile, and other nitrile compounds; and sulfolane, dimethyl sulfoxide, dimethyl formamide, other non-protonic polar compounds, and the like. These may be used alone or two or more types may be used as a mixture.

Among these, ethylene carbonate, propylene carbonate, and other carbonate compounds, γ-butyrolactone, 3-methyl-2-oxazolidinone, 2-methyl pyrolidone, and other heterocyclic compounds, acetonitrile, methoxy acetonitrile, propionitrile, 3-methoxy propionitrile, valeronitrile, and other nitrile compounds are preferred from the viewpoint of dielectric constant. Furthermore, from the viewpoint of output from the photoelectric conversion element, acetonitrile and methoxy acetonitrile are preferred.

In addition, a so-called “ionic liquid” (also called “ambient temperature molten salt”) may be used instead of any such organic solvent. An ionic liquid is preferred because it is nonvolatile and flame-resistant, and the like. Such ionic liquid may be, for example, an imidazolium salt, pyridine salt, ammonium salt, alicyclic amine, aliphatic amine, azonium amine, and the like.

The electrolyte layer 3 may further contain any traditionally known substance as an electrolyte material for photoelectric conversion element. Such substance may be selected from the group that includes pyridine, pyridine derivatives, imidazole, and imidazole derivatives, or it may be boric acid tri-o-cresyl ester ((CH₃C₆H₄O)₃B), gelling agent, etc.

How the electrolyte layer 3 is sealed is not limited in any way, and any known prior art may be referenced as deemed appropriate. Preferably the electrolyte layer 3 contacts the aforementioned sensitizing dye 22 and semiconductor oxide grains 21.

In addition to the constitution explained above, the photoelectric conversion element proposed by the present invention may further have a substrate, sealant, or other constituent, in which case any prior art relating to photoelectric conversion elements may be referenced as deemed appropriate for any such additional constituent.

The photoelectric conversion element proposed by the present invention is particularly suited for use in an environment of low-illumination intensity, and installing it in an electronic apparatus for indoor use is also a favorable embodiment. For example, by implementing the present invention, a photoelectric conversion element capable of generating 7.2×10⁻⁶ W/cm² or more of electricity and 2.0×10⁻⁵ A/cm² or more of electrical current in an environment of 200 lux in illumination intensity can be achieved with ease. As described above, the photoelectric conversion element proposed by the present invention is excellent for use in an environment of low-illumination intensity, which means that it can be installed and used in an electronic component and such electronic component is also an embodiment of the present invention. Examples of such electronic component include, but are not limited to, wireless sensors and beacons in which the photoelectric conversion element proposed by the present invention is incorporated as a main power supply or auxiliary power supply.

### EXAMPLES

The present invention is explained more specifically below using examples. It should be noted, however, that the present invention is not limited to the embodiments described in these examples.

### Example 1

An alcohol solution prepared from titanium alkoxide was coated on a FTO surface of a glass/FTO substrate produced by laminating a glass sheet as a support, with a FTO as an electrode 1, and heated at 550° C. As a result, a semiconductor oxide layer 10 constituted by titanium oxide was formed. A titanium oxide paste (HTSP) manufactured by Solaronics was printed using the screen printing method over an area of 0.16 cm² on the semiconductor oxide layer 10. The coated glass/FTO substrate was heated for approx. 30 minutes at 550° C. to remove the organic components contained in the titanium oxide paste. Semiconductor oxide grains 21 constituted by titanium oxide were thus added onto the electrode 1 via the semiconductor oxide layer 10. A dye solution was prepared by dissolving a dye (CYC-B11 (K)), to a concentration of 0.2 mM, into an organic solvent being a 1:1 mixture of acetonitrile and t-butanol in volume ratio. The glass/FTO substrate to which the semiconductor oxide grains 21 had been added was soaked in this dye solution and kept stationary for 4 hours at 50° C., to adsorb the dye. Separately, platinum was sputtered on the FTO surface of a different glass/FTO substrate to produce a counter-electrode 2, or positive electrode. The dye-adsorbed FTO substrate side of the negative electrode was placed to face the platinum side of the positive electrode, and a spacer constituted by a resin film of 10 um in thickness was placed between the negative electrode and the positive electrode, to produce a small cell. It should be noted that a hole (with an area of 0.25 cm²) slightly larger than the area of the generation layer was opened beforehand at the center of the resin film spacer, and the generation layer was overlaid so that its position would align with the hole in the spacer. Electrolyte was injected into the hole in the spacer immediately before the generation layer was overlaid, to complete the small cell.

For the electrolyte, dimethyl imidazolium iodide (DMII) and iodine I₂ were mixed in acetonitrile so that the concentration of DMII would become 7.2 mol/L and that of I₂, 0.0000003 mol/L.

Observation by an electron microscope found that the individual grains constituting the semiconductor oxide layer 10 were generally 0.5 to 2 nm or so in size and constituted a dense film of approx. 1 to 5 nm in thickness, while the individual semiconductor oxide grains 21 were generally 5 to 20 nm or so in size and scattered sparsely.

When this small cell was evaluated for generation amount W and electrical current at low-illumination intensity, the following results were obtained:

When the illumination intensity was 200 lux, the generation amount was 7.56×10⁻⁶ W/cm².

When the illumination intensity was 200 lux, the electrical current was 2.22×10⁻⁵ A/cm².

### Example 2

A small cell was manufactured in the same manner as in Example 1, except that the concentration of DMII in the electrolyte was changed to 3.6 mol/L.

When this small cell was evaluated for generation amount W and electrical current at low-illumination intensity, the following results were obtained:

When the illumination intensity was 200 lux, the generation amount was 7.45×10⁻⁶ W/cm².

When the illumination intensity was 200 lux, the electrical current was 2.03×10⁻⁵ A/cm².

### Example 3

A small cell was manufactured in the same manner as in Example 1, except that the concentration of dimethyl imidazolium iodide (DMII) in the electrolyte was changed to 3.0 mol/L.

When this small cell was evaluated for generation amount W and electrical current at low-illumination intensity, the following results were obtained:

When the illumination intensity was 200 lux, the generation amount was 7.30×10⁻⁶ W/cm².

When the illumination intensity was 200 lux, the electrical current was 1.89×10⁻⁵ A/cm².

### Example 4

A small cell was manufactured in the same manner as in Example 1, except that the concentration of dimethyl imidazolium iodide (DMII) in the electrolyte was changed to 2.4 mol/L.

When this small cell was evaluated for generation amount W and electrical current at low-illumination intensity, the following results were obtained:

When the illumination intensity was 200 lux, the generation amount was 7.25×10⁻⁶ W/cm².

When the illumination intensity was 200 lux, the electrical current was 2.05×10⁻⁵ A/cm².

### Example 5

A small cell was manufactured in the same manner as in Example 1, except that the concentration of dimethyl imidazolium iodide (DMII) in the electrolyte was changed to 0.9 mol/L.

When this small cell was evaluated for generation amount W and electrical current at low-illumination intensity, the following results were obtained:

When the illumination intensity was 200 lux, the generation amount was 7.13×10⁻⁶ W/cm².

When the illumination intensity was 200 lux, the electrical current was 1.91×10⁻⁵ A/cm².

### Comparative Example 1

A small cell was manufactured in the same manner as in Example 1, except that the concentration of dimethyl imidazolium iodide (DMII) in the electrolyte was changed to 0.6 mol/L.

When this small cell was evaluated for generation amount W and electrical current at low-illumination intensity, the following results were obtained:

When the illumination intensity was 200 lux, the generation amount was 7.01×10⁻⁶ W/cm².

When the illumination intensity was 200 lux, the electrical current was 1.89×10⁻⁵ A/cm².

### Comparative Example 2

A small cell was manufactured in the same manner as in Example 1, except that the semiconductor oxide layer 10 was eliminated.

When this small cell was evaluated for generation amount W and electrical current at low-illumination intensity, the following results were obtained:

When the illumination intensity was 200 lux, the generation amount was 5.61×10⁻⁶ W/cm².

When the illumination intensity was 200 lux, the electrical current was 1.82×10⁻⁵ A/cm².

### Comparative Example 3

A small cell was manufactured in the same manner as in Example 1, except that the step to print the titanium oxide paste (HTSP) manufactured by Solaronics was eliminated. In other words, the electrode and generation electrode were produced with the dye adsorbed onto the semiconductor oxide layer 10 alone.

When this small cell was evaluated for generation amount W and electrical current at low-illumination intensity, the following results were obtained:

When the illumination intensity was 200 lux, the generation amount was 6.38×10⁻⁷ W/cm².

When the illumination intensity was 200 lux, the electrical current was 2.50×10⁻⁶ A/cm².

In the present disclosure where conditions and/or structures are not specified, a skilled artisan in the art can readily provide such conditions and/or structures, in view of the present disclosure, as a matter of routine experimentation. Also, in the present disclosure including the examples described above, any ranges applied in some embodiments may include or exclude the lower and/or upper endpoints, and any values of variables indicated may refer to precise values or approximate values and include equivalents, and may refer to average, median, representative, majority, etc. in some embodiments. Further, in this disclosure, “a” may refer to a species or a genus including multiple species, and “the invention” or “the present invention” may refer to at least one of the embodiments or aspects explicitly, necessarily, or inherently disclosed herein. The terms “constituted by” and “having” refer independently to “typically or broadly comprising”, “comprising”, “consisting essentially of”, or “consisting of” in some embodiments. In this disclosure, any defined meanings do not necessarily exclude ordinary and customary meanings in some embodiments.

The present application claims priority to Japanese Patent Application No. 2016-249194, filed Dec. 22, 2016, the disclosure of which is incorporated herein by reference in its entirety including any and all particular combinations of the features disclosed therein.

It will be understood by those of skill in the art that numerous and various modifications can be made without departing from the spirit of the present invention. Therefore, it should be clearly understood that the forms of the present invention are illustrative only and are not intended to limit the scope of the present invention.

We/I claim:

1. A photoelectric conversion element comprising: an electrode, a counter-electrode, and an electrolyte layer interposed between the electrode and the counter electrode, wherein the photoelectric conversion element further comprises:
a semiconductor oxide layer provided on at least a part of a face of the electrode facing the counter-electrode; and
semiconductor oxide grains and sensitizing dye fixed to the face of the electrode via the semiconductor oxide layer,
wherein the semiconductor oxide layer has a film structure constituted by closely packed grains which are more densely packed than are the fixed semiconductor oxide grains;
the electrolyte layer contains I₃⁻ and I⁻; and
a concentration of I⁻ in the electrolyte layer is 1 to 10 mol/L and is 2 million to 200 million times that of I₃⁻.

2. The photoelectric conversion element according to claim 1, wherein a viscosity of the electrolyte layer at 25° C. is 0.1 mPa·s or higher but no higher than 10 mPa·s.

3. The photoelectric conversion element according to claim 1, which is made to be used indoor.

4. The photoelectric conversion element according to claim 2, which is made to be used indoor.

5. The photoelectric conversion element according to claim 1, which generates 7.2×10⁻⁶ W/cm² or more of electricity and 2.0×10⁻⁵ A/cm² or more of electrical current as measured in an environment of 200 lux in illumination intensity.

6. The photoelectric conversion element according to claim 2, which generates 7.2×10⁻⁶ W/cm² or more of electricity and 2.0×10⁻⁵ A/cm² or more of electrical current as measured in an environment of 200 lux in illumination intensity.

7. The photoelectric conversion element according to claim 3, which generates 7.2×10⁻⁶ W/cm² or more of electricity and 2.0×10⁻⁵ A/cm² or more of electrical current as measured in an environment of 200 lux in illumination intensity.

8. The photoelectric conversion element according to claim 4, which generates 7.2×10⁻⁶ W/cm² or more of electricity and 2.0×10⁻⁵ A/cm² or more of electrical current as measured in an environment of 200 lux in illumination intensity.

9. An electronic component having a photoelectric conversion element according to claim 1.

10. An electronic component having a photoelectric conversion element according to claim 2.

11. An electronic component having a photoelectric conversion element according to claim 3.

12. An electronic component having a photoelectric conversion element according to claim 4.

13. An electronic component having a photoelectric conversion element according to claim 5.

14. An electronic component having a photoelectric conversion element according to claim 6.

15. An electronic component having a photoelectric conversion element according to claim 7.

16. An electronic component having a photoelectric conversion element according to claim 8.
